(19) United States
(12) Patent Application Publication
(10) Pub. No.: US 2020/0407660 A1
(43) Pub. Date: Dec. 31, 2020

(54) LUBRICATING OIL COMPOSITION FOR CONTINUOUSLY VARIABLE TRANSMISSION

(71) Applicants: ENEOS Corporation, Tokyo (JP); HONDA MOTOR Co., Ltd., Tokyo (JP)

(72) Inventors: Hitoshi KOMATSUBARA, Tokyo (JP); Shingo MATSUKI, Tokyo (JP); Toshitaka NAKAMURA, Tokyo (JP); Hiroyuki CHINEN, Tokyo (JP); Yuji MATSUI, Tokyo (JP); Kosei KASHIMA, Tokyo (JP); Yosuke WATANABE, Saitama-ken (JP); Makito NAKASONE, Saitama-ken (JP)

(73) Assignees: ENEOS Corporation, Tokyo (JP); HONDA MOTOR Co., Ltd., Tokyo (JP)

(21) Appl. No.: 16/912,852

(22) Filed: Jun. 26, 2020

(30) Foreign Application Priority Data
Jun. 27, 2019 (JP) 2019-120486

(51) Int. Cl. C10M 169/04; C07F 5/04; C10M 109/00; C10M 161/00; C10M 145/14; C10M 141/12; C10M 139/00; C10M 137/02; C10M 129/74; C10M 129/54

(52) U.S. Cl. CPC C10M 169/04; C07F 5/04; C10M 109/00; C10M 161/00; C10M 145/14; C10N 2040/045; C10M 139/00; C10M 137/02; C10M 129/74; C10M 129/54; C10M 141/12

(57) ABSTRACT

A lubricating oil composition for a push-belt continuously variable transmission includes: (A) a lubricant base oil including at least one wax-isomerized base oil, and having a specific kinematic viscosity and a specific viscosity index; (B) a poly(meth)acrylate having a specific weight average molecular weight; (C) a boron-containing succinimide compound; (D) a borate ester compound; and (E) an overbased calcium detergent, wherein the composition has a kinematic viscosity at 40° C. of no more than 25 mm²/s; a viscosity index of no less than 180; and the ratio of a boron content to a calcium content of 0.5 to 1.5.

### FIELD

The present invention relates to a lubricating oil composition for continuously variable transmissions, and more specifically to a lubricating oil composition for push-belt continuously variable transmissions.

### BACKGROUND

Push-belt continuously variable transmissions are rapidly becoming widespread in recent years since such transmissions are effective at improving fuel efficiency of vehicles. A push-belt continuously variable transmission includes a pair of pulleys including a drive pulley and a driven pulley, and a metal belt looped around the pair of pulleys. The metal belt includes a plurality of metal elements (transverse elements; teeth) that roll around the pair of pulleys as repeatedly engaged with and released from the pulleys, and at least one ringlike metal band (carrier) that supports the plurality of metal elements on a path when rolling around. The drive pulley engages with teeth supported by the carrier of the metal belt to push the teeth towards the driven pulley, which transmits power from the input side (drive pulley) to the output side (driven pulley). The gear ratio thereof is controlled by adjustment of (a) radius/radii of (an) arcuate rolling path(s) of metal elements on one or both of the pulleys. The radius of an arcuate rolling path is adjusted by changing a distance between a pair of conical surfaces of the pulley which hold a metal element.

One means for improving energy efficiency in transmissions is to use a less viscous lubricating oil. It is considered that a less viscous lubricating oil reduces fluid resistance and drag torque which are caused by viscosity resistance of the lubricating oil, and improves power transmission efficiency, and thus can improve fuel efficiency.

### CITATION LIST

### Patent Literature

Patent Literature 1: JP 2014-196396 A

Patent Literature 2: JP 4663843 B2

Patent Literature 3: JP 2018-053017 A

### SUMMARY

### Technical Problem

A less viscous lubricating oil reduces an oil film thickness on a lubricated surface. A reduced oil film thickness in a mixed lubrication regime is considered to be advantageous in view of increase in friction coefficients between metals. A reduced oil film thickness on a lubricated surface however tends to worsen anti-seizure, anti-wear, and anti-fatigue performance.

Another approach to improving energy efficiency in transmissions is to make transmissions smaller and lighter. Smaller and lighter transmissions improve fuel consumption of vehicles on which such transmissions are mounted. Particularly, for push-belt continuously variable transmissions, if a friction coefficient between metals can be increased, (1) a lower oil pressure from an oil pump becomes acceptable, which makes it possible to downsize the oil pump, and (2) the transmissions can be downsized without impairing torque transmitting capacity of a metal belt. Thus, it is desirable that lubricating oils used for push-belt continuously variable transmissions keep high friction coefficients between metals under low sliding velocity conditions. Since continuously variable transmissions include a wet clutch such as a lock-up clutch and a forward/reverse clutch, it is also desirable to keep torque transmitting capacity of such a wet clutch high. It is however desirable that friction coefficients between metals under high sliding velocity conditions be low in view of reduction of a friction loss caused by sliding between gears, bearings, etc. to improve fuel efficiency.

An object of the present invention is to provide a lubricating oil composition for push-belt continuously variable transmissions which can improve fuel efficiency while satisfying anti-seizure, anti-wear, and anti-fatigue performance which are required of push-belt continuously variable transmission oils and keeping high levels of friction coefficients between metals under low sliding velocity conditions and torque transmitting capacity of a wet clutch.

### Solution to Problem

One embodiment of the present invention is a lubricating oil composition for a push-belt continuously variable transmission, the composition comprising: (A) a lubricant base oil having a kinematic viscosity at 100° C. of 2.5 to 3.5 mm²/s and a viscosity index of no less than 120, the (A) lubricant base oil comprising (A1) at least one wax-isomerized base oil in an amount of no less than 50 mass % on the basis of the total mass of the lubricant base oil; (B) at least one poly(meth)acrylate having a weight average molecular weight of 15,000 to 40,000, in an amount of 10 to 20 mass % on the basis of the total mass of the composition; (C) at least one boron-containing succinimide compound, in an amount of 0.01 to 0.03 mass % in terms of boron on the basis of the total mass of the composition; (D) at least one borate ester compound, in an amount of 0.002 to 0.010 mass % in terms of boron on the basis of the total mass of the composition; and (E) at least one calcium salicylate detergent overbased with calcium carbonate and having a base number of 200 to 600 mgKOH/g, or at least one calcium sulfonate detergent overbased with calcium carbonate and having a base number of 200 to 600 mgKOH/g, or any combination thereof, in an amount of 0.01 to 0.05 mass % in terms of calcium on the basis of the total mass of the composition, wherein the composition has a kinematic viscosity at 40° C. of no more than 25 mm²/s; the composition has a viscosity index of no less than 180; and the composition meets the following formula (1):

0.5≤Mb/MCa≤1.5 (1)

wherein in the formula (1), Mb represents a boron content (unit: mass %) of the composition; and MCa represents a calcium content (unit: mass %) of the composition.

In this specification, “(meth)acrylate” means “acrylate and/or methacrylate”.

In the lubricating oil composition, the component (D) is preferably at least one borate ester compound represented by the following general formula (2):

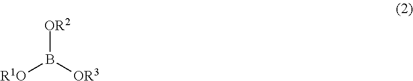

wherein in the general formula (2), R¹ is a hydrocarbyl group having 1 to 30 carbons; and R² and R³ are each independently a hydrogen atom or a hydrocarbyl group having 1 to 30 carbons.

In one preferred embodiment, the lubricating oil composition further comprises: (F) at least one phosphorus-containing anti-wear agent, in an amount of 0.01 to 0.2 mass % in terms of phosphorus on the basis of the total mass of the composition.

In one preferred embodiment, the lubricating oil composition further comprises: (G) at least one ashless friction modifier, in an amount of 0.01 to 5.0 mass % on the basis of the total mass of the composition.

### Advantageous Effects of Invention

The present invention can provide a lubricating oil composition for push-belt continuously variable transmissions which can improve fuel efficiency while satisfying anti-seizure, anti-wear, and anti-fatigue performance which are required of push-belt continuously variable transmission oils and keeping high levels of friction coefficients between metals under low sliding velocity conditions and torque transmitting capacity of a wet clutch.

### DETAILED DESCRIPTION OF EMBODIMENTS

The present invention will be described hereinafter. In the present specification, expression “A to B” concerning numeral values A and B shall be equivalent to “no less than A and no more than B” unless otherwise specified. In such expression, if a unit is added only to the numeral value B, the same unit shall be applied to the numeral value A as well. In the present specification, a word “or” shall mean a logical sum unless otherwise specified. In the present specification, expression “E₁ and/or E₂” concerning elements E₁ and E₂ shall be equivalent to “E₁, or E₂, or the combination thereof”, and expression “E₁, . . . , and/or E_{N}” concerning n elements E₁, . . . , Eᵢ, . . . , E_{N} (N is an integer of 3 or more) shall be equivalent to “E₁, . . . , or Eᵢ, . . . , or E_{N}, or any combination thereof” (i is a variable that can take any of integers satisfying 1<i<N).

In the present specification, unless otherwise specified, the content of each element of calcium, magnesium, zinc, phosphorus, sulfur, boron, barium, and molybdenum in an oil shall be measured by inductively coupled plasma atomic emission spectrometry (intensity ratio method (internal standard method)), conforming to JIS K0116; and the content of a nitrogen element in an oil shall be measured by the chemiluminescence method, conforming to JIS K2609. In the present specification, “weight average molecular weight” means a weight average molecular weight measured by gel permeation chromatography (GPC) in terms of standard polystyrene. The measurement conditions for GPC are as follows:

### [GPC Measurement Conditions]

device: ACQUITY™ APC UV RI System manufactured by Waters Corporation

column: in order from the upstream side, 2 columns of ACQUITY™ APC XT900A manufactured by Waters Corporation (gel particle size: 2.5 column size (inner diameter×length): 4.6 mm×150 mm), and 1 column of ACQUITY™ APC XT200A manufactured by Waters Corporation (gel particle size: 2.5 column size (inner diameter×length): 4.6 mm×150 mm) are connected in series

column temperature: 40° C.

sample solution: tetrahydrofuran solution whose sample concentration is 1.0 mass %

solution injection volume: 20.0 μL

detector: differential refractometer

standard material: standard polystyrene (Agilent EasiCal™ PS-1 manufactured by Agilent Technologies, Inc.) (8 points of molecular weight: 2698000, 597500, 290300, 133500, 70500, 30230, 9590 and 2970)

When the weight average molecular weight measured based on the foregoing conditions is less than 10000, the columns and standard material are changed according to the following conditions, to make remeasurement.

column: in order from the upstream side, 1 column of ACQUITY™ APC XT125A manufactured by Waters Corporation (gel particle size: 2.5 μm, column size (inner diameter×length): 4.6 mm×150 mm), and 2 columns of ACQUITY™ APC XT45A manufactured by Waters Corporation (gel particle size: 1.7 μm, column size (inner diameter×length): 4.6 mm×150 μm) are connected in series

standard material: standard polystyrene (Agilent EasiCal™ PS-1 manufactured by Agilent Technologies, Inc.) (10 points of molecular weight: 30230, 9590, 2970, 890, 786, 682, 578, 474, 370 and 266)

<(A) Lubricant Base Oil>

A lubricant base oil (total base oil) (hereinafter may be referred to as “lubricant base oil of the present embodiment” or “component (A)”) in a lubricating oil composition for push-belt continuously variable transmissions of the present invention (hereinafter may be referred to as “continuously variable transmission oil” or “lubricating oil composition”) is a base oil having a kinematic viscosity at 100° C. of 2.5 to 3.5 mm²/s and a viscosity index of no less than 120, the lubricant base oil comprising (A1) at least one wax-isomerized base oil in an amount of no less than 50 mass % on the basis of the total mass of the lubricant base oil. Using the lubricant base oil of the present embodiment makes it possible to reduce traction coefficients, that is, improve fuel efficiency.

The (A1) wax-isomerized base oil means a base oil obtained by isomerization of wax such as petroleum wax, and GTL (Gas to Liquid) wax (such as Fischer-Tropsch synthetic oil). One wax-isomerized base oil may be used alone, and two or more wax-isomerized base oils may be used in combination.

The kinematic viscosity of the (A1) wax-isomerized base oil (total wax-isomerized base oil) at 100° C. is preferably no more than 4.0 mm²/s, and in one embodiment may be no more than 3.9 mm²/s, in view of low-temperature viscosity properties of the lubricating oil composition and further improvement in fuel efficiency; and is preferably no less than 2.5 mm²/s, and in one embodiment may be no less than 2.6 mm²/s, in view of sufficient oil film formation at a lubricating point to further improve anti-seizure, anti-wear, and anti-fatigue performance. This kinematic viscosity at 100° C., in one embodiment, may be 2.5 to 4.0 mm²/s, or 2.6 to 3.9 mm²/s. In the present specification, “kinematic viscosity at 100° C.” means kinematic viscosity at 100° C. specified in JIS K 2283-1993.

The viscosity index of the (A1) wax-isomerized base oil (total wax-isomerized base oil) is preferably no less than 120, and more preferably no less than 125, in view of viscosity-temperature characteristics of the lubricating oil composition, and further reduction of traction coefficients to further improve fuel efficiency. In the present specification, a viscosity index means a viscosity index measured conforming to JIS K 22834993. The upper limit of the viscosity index of the total wax-isomerized base oil is not particularly limited, but is usually no more than 150, and for example, may be no more than 145.

The component (A) may further comprise a (A2) base oil component other than wax-isomerized base oils. At least one mineral base oil, at least one synthetic base oil, or any mixed base oil thereof which is a base oil component other than wax-isomerized base oils may be used as the (A2) base oil component other than wax-isomerized base oils. In one embodiment, as the (A2) base oil component other than wax-isomerized base oils, a Group II base oil, a Group III base oil, a Group IV base oil, or a Group V base oil of API base stock categories, or any mixed base oil thereof may be preferably used, and a Group II base oil, a Group III base oil, or a Group IV base oil, or any mixed base oil thereof may be more preferably used. In one embodiment, a mixture of at least one wax-isomerized base oil and at least one API Group II base oil may be used as the component (A). API Group II base oils are mineral base oils containing no more than 0.03 mass % of sulfur and no less than 90 mass % of saturates, and having a viscosity index of no less than 80 and less than 120. API Group III base oils are mineral base oils containing no more than 0.03 mass % of sulfur and no less than 90 mass % of saturates, and having a viscosity index of no less than 120. API Group IV base oils are poly-α-olefin base oils. API Group V base oils are ester base oils. In the present specification, “sulfur content in the lubricant base oil” shall be measured conforming to JIS K 2541-2003.

Mineral base oils may include paraffinic or naphthenic mineral base oils obtained through application of one or at least two of refining means in suitable combination, such as solvent deasphalting, solvent extraction, hydrocracking, solvent dewaxing, catalytic dewaxing, hydrorefining, sulfuric acid washing, and white clay treatment, to lubricant oil fractions that are obtained by distillation of crude oil under atmospheric pressure and under reduced pressure. API Group II base oils and Group III base oils are usually produced via hydrocracking.

Examples of API Group IV base oils include ethylene-propylene copolymers, polybutene, 1-octene oligomers, and 1-decene oligomers, and hydrogenated products thereof.

Examples of API Group V base oils include monoesters (such as butyl stearate, octyl laurate, and 2-ethylhexyl oleate); diesters (such as ditridecyl glutarate, bis(2-ethylhexyl) adipate, diisodecyl adipate, ditridecyl adipate, and bis(2-ethylhexyl) sebacate); polyesters (such as trimellitate esters); and polyol esters (such as trimethylolpropane caprylate, trimethylolpropane pelargonate, pentaerythritol 2-ethylhexanoate, and pentaerythritol pelargonate).

% C_{P} of the total base oil is preferably no less than 70, and more preferably no less than 80, in view of viscosity-temperature characteristics and thermal oxidation stability, and in view of further improvement in friction properties; and is usually no more than 99, and preferably no more than 95, in view of solubility of additives.

% C_{A} of the total base oil is preferably no more than 2, more preferably no more than 1, further preferably no more than 0.8, and particularly preferably no more than 0.5, in view of viscosity-temperature characteristics and thermal oxidation stability, and in view of further improvement in fuel efficiency.

% C_{N} of the total base oil is preferably no more than 30, and more preferably no more than 25, in view of viscosity-temperature characteristics and thermal oxidation stability, and in view of further improvement in friction properties; and is preferably no less than 1, and more preferably no less than 4, in view of solubility of additives.

In the present specification, % C_{P}, % C_{N} and % C_{A} mean percentage of the paraffinic carbon number to all the carbon atoms, percentage of the naphthenic carbon number to all the carbon atoms, and percentage of the aromatic carbon number to all the carbon atoms, which are obtained by the method conforming to ASTM D 3238-85 (n-d-M ring analysis), respectively. That is, the above described preferred ranges of % C_{P}, % C_{N}, and % C_{A} are based on values obtained according to the above method. For example, the value of % C_{N} obtained according to the above method can indicate more than 0 even if a base oil does not contain any naphthenes.

The kinematic viscosity of the total base oil at 100° C. is 2.5 to 3.5 mm²/s, and preferably 2.6 to 3.4 mm²/s. The kinematic viscosity of the total base oil at 100° C. at this upper limit or below offers improved low-temperature viscosity characteristics of the lubricating oil composition, and improved fuel efficiency. The kinematic viscosity of the total base oil at 100° C. at this lower limit or above offers sufficient oil film formation at a lubricating point, and thus improved anti-seizure, anti-wear, and anti-fatigue performance.

The kinematic viscosity of the total base oil at 40° C. is, in view of low-temperature viscosity properties of the lubricating oil composition, and in view of further improvement in fuel efficiency, preferably no more than 40 mm²/s, more preferably no more than 30 mm²/s, further preferably no more than 20 mm²/s, and particularly preferably no more than 15 mm²/s; and in view of sufficient oil film formation at a lubricating point to further improve anti-seizure, anti-wear, and anti-fatigue performance, preferably no less than 8.0 mm²/s, more preferably no less than 8.5 mm²/s, and particularly preferably no less than 9.0 mm²/s; and in one embodiment, may be 8.0 to 40 mm²/s, 8.5 to 30 mm²/s, 8.5 to 20 mm²/s, or 9.0 to 15 mm²/s. In the present specification, “kinematic viscosity at 40° C.” means a kinematic viscosity at 40° C. specified in JIS K 2283-1993.

The viscosity index of the total base oil is no less than 120, and more preferably no less than 125. The viscosity index of the total base oil at this lower limit or above makes it possible to not only improve viscosity-temperature characteristics of the lubricating oil composition, but also reduce traction coefficients, that is, improve fuel efficiency. The upper limit of the viscosity index of the total base oil is not particularly limited, but usually no more than 150, and for example, may be no more than 145.

The pour point of the total base oil is preferably no more than −10° C., more preferably no more than −12.5° C., further preferably no more than −15° C., especially preferably no more than −17.5° C., and most preferably no more than −20.0° C., in view of low-temperature fluidity of the entire lubricating oil composition. The pour point in the present specification means a pour point measured conforming to JIS K 2269-1987.

The sulfur content in the total base oil is usually no more than 0.03 mass %, and in view of oxidation stability, preferably no more than 0.01 mass %. In the present specification, the sulfur content in the total base oil means a sulfur content measured conforming to JIS K 2541-2003.

The content of the total (A1) wax-isomerized base oil in the (A) lubricant base oil is no less than 50 mass %, and may be 50 to 100 mass %, on the basis of the total mass of the lubricant base oil.

The content of the lubricant base oil (total base oil) in the lubricating oil composition is no less than 60 mass %, preferably 60 to 88.5 mass %, and more preferably 70 to 88.5 mass %, and in one embodiment, may be 75 to 85 mass %, on the basis of the total mass of the lubricating oil composition.

<(B) Poly(Meth)Acrylate>

The lubricating oil composition of the present invention comprises at least one poly(meth)acrylate having a weight average molecular weight of 15,000 to 40,000 (hereinafter may be referred to as “component (B)”), in an amount of 10 to 20 mass % on the basis of the total mass of the composition. In the present specification, “(meth)acrylate” means “acrylate and/or methacrylate”. One poly(meth)acrylate may be used alone, or two or more poly(meth)acrylates may be used in combination as the component (B).

The component (B) may be a dispersant poly(meth)acrylate, may be a non-dispersant poly(meth)acrylate, and may be any mixture thereof. In one embodiment, a non-dispersant poly(meth)acrylate may be preferably used. In the present specification, while a dispersant poly(meth)acrylate compound has a functional group including a nitrogen atom, a non-dispersant poly(meth)acrylate compound does not have a functional group including a nitrogen atom. The weight average molecular weight of the component (B) is 15,000 to 40,000. The weight average molecular weight of the component (B) of no more than 40,000 can improve shear stability of the lubricating oil composition, and can reduce friction coefficients between metals under high sliding velocity conditions (that is, friction coefficients in sliding between gears, bearings, etc.), to improve fuel efficiency. The weight average molecular weight of the component (B) of no less than 15,000 can increase the viscosity index of the lubricating oil composition.

The component (B) functions as a viscosity index improver. The content of the component (B) in the lubricating oil composition is 10 to 20 mass % on the basis of the total mass of the composition, and may be such that the kinematic viscosity at 40° C. and the viscosity index of the lubricating oil composition are within a range which will be discussed below. The content of the component (B) within this range can improve temperature-viscosity characteristics of the lubricating oil composition, and can reduce friction coefficients between metals under high sliding velocity conditions, to improve fuel efficiency.

<(C) Boron-Containing Succinimide Compound>

The lubricating oil composition of the present invention comprises at least one boron-containing succinimide compound (hereinafter may be referred to as “component (C)”), in an amount of 0.01 to 0.03 mass % in terms of boron on the basis of the total mass of the composition. One compound may be used alone, or two or more compounds may be used in combination as the component (C).

For example, a boronated derivative of a succinimide compound having at least one alkyl or alkenyl group in its molecule may be preferably used as the component (C).

Examples of succinimide compounds having at least one alkyl or alkenyl group in their molecule include compounds represented by the following general formula (3) or (4):

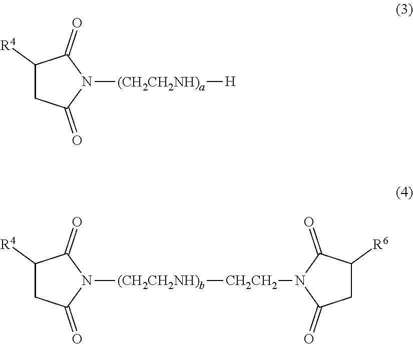

In the formula (3), R⁴ represents a C₄₀₋₄₀₀ alkyl or alkenyl group, a is an integer of 1 to 5, which is preferably 2 to 4. The carbon number of R⁴ is preferably no less than 40, and more preferably no less than 60, in view of solubility in the lubricant base oil; and preferably no more than 400, and more preferably no more than 350, in view of low-temperature fluidity of the lubricating oil composition; and in one embodiment, may be 60 to 350.

In the formula (4), R⁵ and R⁶ each independently represent a C₄₀₋₄₀₀ alkyl or alkenyl group, and may be any combination of different groups. R⁵ and R⁶ are especially preferably polybutenyl groups. b represents an integer of 0 to 4, which is preferably 1 to 4, and more preferably 1 to 3. Carbon numbers of R⁵ and R⁶ are preferably no less than 40, and more preferably no less than 60, in view of solubility in the lubricant base oil; and preferably no more than 400, and more preferably no more than 350, in view of low-temperature fluidity of the lubricating oil composition; and in one embodiment, may be 60 to 350.

The alkyl or alkenyl groups (R⁴ to R⁶) in the formulae (3) and (4) may be linear or branched. Preferred examples thereof include branched alkyl groups and branched alkenyl groups derived from oligomers of olefins such as propene, 1-butene, and isobutene, and from co-oligomers of ethylene and propylene. Among them, branched alkyl or alkenyl groups derived from oligomers of isobutene that are conventionally referred to as polyisobutylene, and a polybutenyl group are most preferable.

Preferred number average molecular weights of the alkyl or alkenyl groups (R⁴ to R⁶) in the formulae (3) and (4) are 800 to 3500, and preferably 1000 to 3500.

Succinimide compounds having at least one alkyl or alkenyl group in their molecules include so-called monotype succinimide represented by the formula (3) wherein addition of a succinic anhydride has occurred at only one end of a polyamine chain, and so-called bistype succinimide represented by the formula (4) wherein addition of succinic anhydrides has occurred at both ends of a polyamine chain. The component (C) may include either monotype or bistype succinimide, and may include both of them as a mixture. The content of a bistype succinimide compound in the component (C) is preferably no less than 50 mass %, and more preferably no less than 70 mass %, on the basis of the total mass (100 mass %) of the component (C).

The way of producing a succinimide compound having at least one alkyl or alkenyl group in its molecule is not specifically limited. For example, such succinimide can be obtained as a condensation reaction product by: reaction of an alkyl or alkenyl succinic acid having a C₄₀₋₄₀₀ alkyl or alkenyl group, or an anhydride thereof, with a polyamine. A condensation product of an alkyl or alkenyl succinic acid, or an anhydride thereof, and a polyamine may be a bistype succinimide where both ends of a polyamine chain are imidated (see the general formula (4)), may be a monotype succinimide where only one end of a polyamine chain is imidated (see the general formula (3)), and may be a mixture thereof. Here, an alkenyl succinic acid anhydride having a C₄₀₋₄₀₀ alkenyl group can be obtained by, for example, reaction of a C₄₀₋₄₀₀ olefin and maleic anhydride at 100 to 200° C. This alkenyl succinic acid anhydride may be further subjected to hydrogenation reaction, to obtain an alkyl succinic acid anhydride having a C₄₀₋₄₀₀ alkyl group. Examples of the polyamine include diethylenetriamine, triethylenetetramine, tetraethylenepentamine, and pentaethylenehexamine, and any mixtures thereof. A polyamine raw material comprising at least one selected from them may be preferably used. The polyamine raw material may optionally further comprise ethylenediamine. In view of improvement in the performance of the condensation product or a derivative thereof as a dispersant, the content of ethylenediamine in the polyamine raw material is preferably 0 to 10 mass %, and more preferably 0 to 5 mass %, on the basis of the total mass of the polyamine(s). Succinimide obtained as a condensation reaction product of an alkyl or alkenyl succinic acid having a C₄₀₋₄₀₀ alkyl or alkenyl group, or an anhydride thereof, and a mixture of at least two polyamines, is a mixture of compounds of the general formulae (3) or (4) different in values of a or b, respectively.

For example, a boronated derivative that is obtained by making boric acid react with the above described succinimide compound having at least one alkyl or alkenyl group in its molecule may be preferably used as the component (C). In this boronated derivative, a part or all of the residual amino and/or imino groups in the succinimide compound is/are neutralized or amidated by boric acid.

A preferred weight average molecular weight of the component (C) is preferably 1000 to 20000, more preferably 2000 to 20000, further preferably 2000 to 15000, and particularly preferably 2000 to 9000.

The content of the component (C) in the lubricating oil composition is 0.01 to 0.03 mass % in terms of boron on the basis of the total mass of the lubricating oil composition. The boron content derived from the component (C) at this lower limit or more can improve friction coefficients between metals under low sliding velocity conditions (that is, torque transmitting capacity of a metal belt), anti-wear performance, and torque transmitting capacity of a wet clutch. The boron content derived from the component (C) at this upper limit or below can improve anti-seizure and anti-fatigue performance, and can reduce friction coefficients between metals under high sliding velocity conditions (that is, friction coefficients in sliding between gears, bearings, etc.), to improve fuel efficiency.

The component (C) functions as an ashless dispersant. In the lubricating oil composition of the present invention, the component (C) may be combined with a non-boron-containing ashless dispersant. For example, any succinimide compound having at least one C₄₀₋₄₀₀ alkyl or alkenyl group in its molecule, represented by the general formula (3) or (4) may be preferably used as a non-boron-containing ashless dispersant. The nitrogen content in the lubricating oil composition which is derived from any ashless dispersant including the component (C) on the basis of the total mass of the lubricating oil composition is preferably no less than 100 mass ppm, and more preferably no less than 400 mass ppm, in view of an anti-coking property (thermal stability) of the lubricating oil composition; preferably no more than 2000 mass ppm, and more preferably no more than 1000 mass ppm, in view of further improvement in fuel efficiency; and in one embodiment, may be 100 to 2000 mass ppm, or 400 to 1000 mass ppm.

<(D) Borate Ester Compound>

The lubricating oil composition of the present invention comprises at least one borate ester compound (hereinafter may be referred to as “component (D)”), in an amount of 0.002 to 0.010 mass % in terms of boron on the basis of the total mass of the composition. One compound may be used alone, or two or more compounds may be used in combination as the component (D).

Any borate ester compound represented by the following general formula (2) may be used as the component (D).

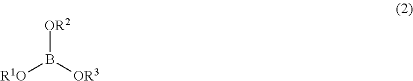

wherein in the general formula (2), R¹ is a C₁₋₃₀ hydrocarbyl group; and R² and R³ are each independently a hydrogen atom or a C₁₋₃₀ hydrocarbyl group.

Examples of the hydrocarbyl group include an alkyl group (that may have a ring structure), an alkenyl group (that may have a double bond at any position, and may have a ring structure), an aryl group, an alkylaryl group, an alkenylaryl group, an arylalkyl group, and an arylalkenyl group.

Alkyl groups include various linear or branched chain alkyl groups. Examples of an alkyl group having a ring structure include an alkylcycloalkyl group and a cycloalkylalkyl group. Examples of a cycloalkyl group include C₅₋₇ cycloalkyl groups such as cyclopentyl group, cyclohexyl group, and cycloheptyl group. A cycloalkyl ring may be substituted in any position.

Alkenyl groups include various linear or branched alkenyl groups. Examples of an alkenyl group having a ring structure include an alkylcycloalkenyl group, an alkenylcycloalkyl group, a cycloalkenylalkyl group, and a cycloalkenylalkenyl group. A cycloalkyl group is the same as the above. Examples of a cycloalkenyl group include C₅₋₇ cycloalkenyl groups having carbon number of 5 to 7 such as cyclopentenyl group, cyclohexenyl group, and cycloheptenyl group. A cycloalkenyl ring and a cycloalkyl ring may be substituted in any position.

Aryl groups include phenyl group and naphthyl group. An aryl group may have a hydrocarbyl substituent. In the above described alkylaryl group, alkenylaryl group, arylalkyl group, and arylalkenyl group, an aryl group may be substituted in any position.

The C₁₋₃₀ hydrocarbyl group in the general formula (2) is preferably a linear or branched chain alkyl or alkenyl group, and more preferably a linear or branched chain alkyl group. The carbon number is preferably no less than 3, and more preferably no less than 5, in view of solubility in the lubricant base oil and in view of further improvement in friction coefficients between metals under low sliding velocity conditions; and preferably no more than 30, more preferably no more than 24, and further preferably no more than 12, in view of further increasing friction coefficients between metals under low sliding velocity conditions; and in one embodiment, may be 3 to 24, or 5 to 12.

In the general formula (2), preferably at least one of R² and R³ is a hydrogen atom, and more preferably both R² and R³ are hydrogen atoms, in view of strengthening a lubricating film in a boundary lubrication regime, to further improve anti-seizure and anti-wear performance.

One preferred example of the component (D) is a borate ester compound represented by the general formula (2) wherein R¹ is a C₃₋₁₂ linear or branched chain alkyl or alkenyl group, and R² and R³ are hydrogen atoms.

The content of the component (D) in the lubricating oil composition is 0.002 to 0.010 mass % in terms of boron (as boron atom content) on the basis of the total mass of the lubricating oil composition. The content of the component (D) at this lower limit or above makes it possible to strengthen a lubricating film in a boundary lubrication regime, to improve anti-wear performance, and can increase friction coefficients between metals under low sliding velocity conditions (torque transmitting capacity of a metal belt) and torque transmitting capacity of a wet clutch. The content of the component (D) at this upper limit or below makes it possible to strengthen a lubricating film in a boundary lubrication regime, to improve anti-fatigue performance, and can reduce friction coefficients between metals under high sliding velocity conditions (friction coefficients in sliding between gears, bearings, etc.), to improve fuel efficiency.

<(E) Calcium Detergent>

The lubricating oil composition of the present invention comprises at least one calcium salicylate detergent overbased with calcium carbonate and having a base number of 200 to 600 mgKOH/g, or at least one calcium sulfonate detergent overbased with calcium carbonate and having a base number of 200 to 600 mgKOH/g, or any combination thereof (hereinafter may be referred to as “component (E)”), in an amount of 0.01 to 0.05 mass % in terms of calcium on the basis of the total mass of the composition.

Preferred examples of the calcium sulfonate detergent overbased with calcium carbonate include: overbased salts of calcium salts of alkylaromatic sulfonic acids obtainable by sulfonation of alkylaromatics. The weight average molecular weights of the alkylaromatics are preferably 400 to 1500, and more preferably 700 to 1300.

Examples of the alkylaromatic sulfonic acids include so-called petroleum sulfonic acids and synthetic sulfonic acids. Examples of petroleum sulfonic acids here include sulfonated products of alkylaromatics of lubricant oil fractions derived from mineral oils, and what is called mahogany acid, which is side product of a white oil. Example of synthetic sulfonic acids include sulfonated products of alkylbenzenes having a linear or branched alkyl group, which is obtainable by: recovery of side product in a manufacturing plant of alkylbenzene, which is a raw material of detergents; or alkylation of benzene with a polyolefin. Other examples of synthetic sulfonic acids include sulfonated products of alkylnaphthalenes such as dinonylnaphthalene. A sulfonating agent used when sulfonating these alkylaromatics is not specifically limited. For example, fuming sulfuric acid or sulfuric anhydride may be used.

Preferred examples of the calcium salicylate detergent overbased with calcium carbonate include overbased salts of calcium salicylates. Preferred examples of calcium salicylates include any compound represented by the following general formula (5):

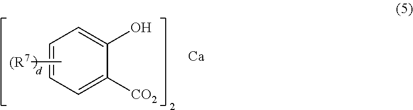

In the formula (5), R⁷ each independently represent a C₁₄₋₃₀ alkyl or alkenyl group, and d represents 1 or 2, which is preferably 1. When d=2, R⁷ may be any combination of different groups.

The way of producing the calcium salicylate is not specifically limited, and any known way of producing monoalkylsalicylates may be employed. For example, the calcium salicylate can be obtained by: making a metal base such as oxides and hydroxides of calcium react with a monoalkylsalicylic acid obtained by alkylating a phenol as a starting material with an olefin, and then carboxylating the resultant product with carbonic acid gas or the like, or with a monoalkylsalicylic acid obtained by alkylating a salicylic acid as a starting material with an equivalent of the olefin, or the like; converting the above monoalkylsalicylic acid or the like to an alkali metal salt such as a sodium salt and a potassium salt, and then performing transmetallation with a calcium salt; or the like.

The way of obtaining a calcium sulfonate or salicylate overbased with calcium carbonate is not specifically limited. For example, a calcium sulfonate or salicylate can be made to react with a base such as calcium hydroxide in the presence of carbonic acid gas, to obtain a calcium sulfonate or salicylate overbased with calcium carbonate.

The base number of the component (E) is 200 to 600 mgKOH/g, and preferably 250 to 550 mgKOH/g. The base number of the component (E) at the lower limit or more can improve anti-wear and anti-seizure performance, and can increase friction coefficients between metals under low sliding velocity conditions (torque transmitting capacity of a metal belt) and torque transmitting capacity of a wet clutch. In the present specification, a base number means a base number measured by the perchloric acid method, conforming to ASTM D 2896.

The content of the component (E) in the lubricating oil composition is 0.01 to 0.05 mass %, and preferably no less than 0.02 mass %, in terms of calcium (as calcium element content) on the basis of the total mass of the lubricating oil composition. The content of the component (E) at this lower limit or above can improve anti-seizure, anti-wear, and anti-fatigue performance, and can increase friction coefficients between metals under low sliding velocity conditions (torque transmitting capacity of a metal belt) and torque transmitting capacity of a wet clutch. The content of the component (E) at this upper limit or below can improve anti-fatigue performance, and can reduce friction coefficients between metals under high sliding velocity conditions (friction coefficients in sliding between gears, bearings, etc.), to improve fuel efficiency.

<(F) Phosphorus-Containing Anti-Wear Agent>

In one preferred embodiment, the lubricating oil composition may further comprise at least one phosphorus-containing anti-wear agent (hereinafter may be referred to as “component (F)”). One anti-wear agent may be used alone, or two or more anti-wear agents may be used in combination as the component (F).

Examples of the component (F) include zinc dialkyldithiophosphate, phosphoric acid monoesters, phosphoric acid diesters, phosphoric acid triesters, phosphoric acid, phosphorous acid monoesters, phosphorous acid diesters, phosphorous acid triesters, salts of phosphoric acid incomplete esters, salts of phosphorous acid incomplete esters, and mixtures thereof.

In the above examples, compounds other than phosphorous acid are usually compounds having a C₂₋₃₀, preferably C₃₋₂₀ hydrocarbon group. Specific examples of the C₂₋₃₀ hydrocarbon group include an alkyl group, a cycloalkyl group, an alkyl-substituted cycloalkyl group, an alkenyl group, an aryl group, an alkyl-substituted aryl group, and aryl-substituted alkyl group. These alkyl groups may be either linear or branched.

Examples of the above described salts of phosphoric acid incomplete esters and salts of phosphorous acid incomplete esters include salts where part or all of the residual acidic hydrogen is/are neutralized by making a nitrogen-containing compound such as ammonia or amine compounds containing only a C₁₋₈ hydrocarbon group or C₁₋₈ hydroxy group-containing hydrocarbon group in their molecules react with a phosphoric acid monoester, a phosphoric acid diester, a phosphorous acid monoester, or a phosphorous acid diester, or any mixture thereof.

A phosphorous acid ester or a salt thereof may be preferably used as the component (F). A phosphorous acid incomplete ester or a salt thereof is more preferable, and a phosphorous acid incomplete ester or a salt thereof having a hydrocarbon group having a carbon number of 8 or less is especially preferable. In the present specification, any tautomer of phosphorous acid esters shall fall under the component (F).

When the lubricating oil composition comprises the component (F), the content thereof in terms of phosphorus on the basis of the total mass of the lubricating oil composition is preferably no less than 0.01 mass %, more preferably no less than 0.02 mass %, and further preferably no less than 0.05 mass %, in view of further improvement in anti-wear performance, and further increase in friction coefficients between metals under low sliding velocity conditions; and preferably no more than 0.2 mass %, and more preferably no more than 0.1 mass % in view of oxidation stability and compatibility with sealing; and in one embodiment, may be 0.01 to 0.2 mass %, 0.02 to 0.1 mass %, or 0.05 to 0.1 mass %.

<(G) Friction Modifier>

In one preferred embodiment, the lubricating oil composition may further comprise at least one friction modifier (hereinafter may be referred to as “component (G)”). One friction modifier may be used alone, or two or more friction modifiers may be used in combination as the component (G).

As the component (G), a compound used as a friction modifier in the field of lubricant oils can be used without particular limitations. Examples of friction modifiers include C₆₋₅₀ compounds containing, in their molecules, at least one heteroatom selected from an oxygen atom, a nitrogen atom and a sulfur atom. More specifically, any friction modifier such as aliphatic amine compounds, aliphatic imide compounds, fatty acid esters, fatty acid amides, fatty acid hydrazides, fatty acid metal salts, aliphatic alcohols, aliphatic ethers, and aliphatic urea compounds, each having at least one C₆₋₃₀ linear or branched chain alkyl or alkenyl group in its molecule, may be preferably used.

Examples of the aliphatic amine compounds include C₆₋₃₀ linear or branched chain aliphatic monoamines; C₆₋₃₀ linear or branched chain aliphatic polyamines; and alkylene oxide adducts of these aliphatic amines.

Examples of the aliphatic imide compounds include succinimides having a C₆₋₃₀ linear or branched chain alkyl or alkenyl group; and modified products thereof by carboxylic acids, boric acid, phosphoric acid, sulfuric acid, or the like.

Examples of the fatty acid esters include esters of C₆₋₃₀ linear or branched fatty acids, and aliphatic monoalcohols or aliphatic polyols.

Examples of the fatty acid amides include condensation products (amides) of C₆₋₃₀ linear or branched chain fatty acids, and aliphatic monoamines, aliphatic polyamines, ammonia, or ethyleneamines (such as linear or branched chain ethyleneamines including ethylenediamine, diethylenetriamine, triethylenetetramine, tris(2-aminoethyl)amine, tetraethylenepentamine, pentaethylenehexamine, N-(2-aminoethyl)piperazine, N,N′-bis(2-aminoethyl)piperazine, piperazinoethylethylenediamine, N,N,N′-tris(2-aminoethyl)ethylenediamine, and N-(2-(4-(2-aminoethyl)piperazine-1-yl)ethyl)ethylenediamine).

Examples of the fatty acid hydrazides include condensation products of C₆₋₃₀ linear or branched fatty acids, and unsubstituted or substituted aliphatic hydrazines.

Examples of the fatty acid metal salts include alkaline earth metal salts (such as a magnesium salt and a calcium salt) and a zinc salt of C₆₋₃₀ linear or branched chain fatty acids.

In one embodiment, a fatty acid ester and/or a fatty acid amide may be preferably used as the component (G).

When the lubricating oil composition comprises the component (G), the content thereof on the basis of the total mass of the lubricating oil composition is preferably no less than 0.01 mass %, more preferably no less than 0.1 mass %, and further preferably no less than 0.3 mass %, in view of improvement in shudder prevention performance of a wet clutch; and preferably no more than 5.0 mass %, more preferably no more than 3.0 mass %, and further preferably no more than 2.0 mass %, in view of further increase in friction coefficients between metals under low sliding velocity conditions; and in one embodiment, may be 0.01 to 5.0 mass %, 0.1 to 5.0 mass %, 0.1 to 3.0 mass %, or 0.3 to 2.0 mass %.

<(H) Thiadiazole Compound>

In one preferred embodiment, the lubricating oil composition may further comprise at least one thiadiazole compound (hereinafter may be referred to as “component (H)”).

Examples of the component (H) include 1,3,4-thiadiazole compounds represented by the following general formula (6), 1,2,4-thiadiazole compounds represented by the following general formula (7), and 1,2,3-thiadiazole compounds represented by the following general formula (8):

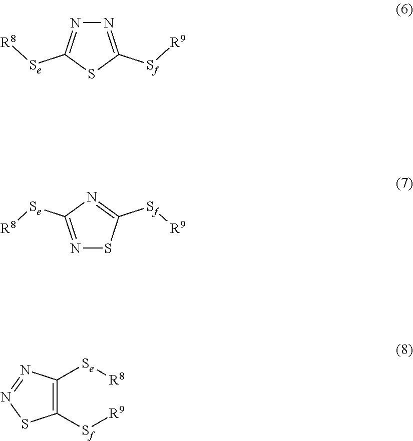

wherein in the general formulae (6) to (8), R⁸ and R⁹ may be the same or may be different, and each independently represent hydrogen or a C₁₋₂₀ hydrocarbyl group; and e and f may be the same or may be different, and each independently represent an integer of 0 to 8.

A thiadiazole compound represented by any of the above general formulae (6) to (8) and having a hydrocarbyldithio group may be especially preferably used among the above thiadiazole compounds.

The sulfur content of the component (H) in the lubricating oil composition (as sulfur atom content) on the basis of the total mass of the lubricating oil composition is preferably no less than 0.02 mass %, and more preferably no less than 0.03 mass %, in view of further improvement in anti-seizure, anti-wear, and anti-fatigue performance, and further increase in friction coefficients between metals under low sliding velocity conditions; and preferably no more than 0.09 mass %, and more preferably no more than 0.08 mass %, in view of further improvement in anti-seizure and anti-fatigue performance; and in one embodiment, may be 0.02 to 0.09 mass %, or 0.03 to 0.08 mass %.

<Other Additives>

In one embodiment, the lubricating oil composition may further comprise at least one selected from an anti-wear agent or extreme-pressure agent other than the component (F), an antioxidant, a viscosity index improver other than the component (B), a pour point depressant other than the component (B), a corrosion inhibitor other than the component (H), an anti-rust agent, a metal deactivator other than the component (H), a defoaming agent, a demulsifier, and a coloring agent.

Examples of anti-wear agents or extreme-pressure agents other than the component (F) include sulfur-based compounds such as disulfides, sulfurized olefins, and sulfurized oils. When the lubricating oil composition comprises an anti-wear agent or extreme-pressure agent other than the component (F), the content thereof is usually 0.01 to 5 mass % on the basis of the total mass of the lubricating oil composition.

Examples antioxidants include phenolic or amine ashless antioxidants, and copper or molybdenum metallic antioxidants. Specific examples of phenolic ashless antioxidants include 4,4′-methylenebis(2,6-di-tert-butylphenol), and 4,4′-bis(2,6-di-tert-butylphenol); and specific examples of amine ashless antioxidants include phenyl-α-naphthylamine, alkylphenyl-α-naphthylamine, and dialkyldiphenylamine. When the lubricating oil composition comprises an antioxidant, the content thereof is usually 0.01 to 5 mass % on the basis of the total mass of the lubricating oil composition.

As a viscosity index improver other than the component (B), any known viscosity index improver used in lubricant oils may be used without particular limitations. Examples thereof include ethylene-α-olefin copolymers and hydrogenated products thereof, copolymers of an α-olefin and an ester monomer having a polymerizable unsaturated bond, polyisobutylene and hydrogenated products thereof, hydrogenated products of styrene-diene copolymers, styrene-maleic anhydride/ester copolymers, and polyalkylstyrene. Among them, an ethylene-α-olefin copolymer or a hydrogenated product thereof, or any combination thereof may be preferably used. The viscosity index improver may be a dispersant viscosity index improver, or may be a non-dispersant viscosity index improver. In one embodiment, for example, the weight average molecular weight of the viscosity index improver may be 2000 to 30000. When the lubricating oil composition comprises the viscosity index improver, the content thereof is usually 0.1 to 10 mass % on the basis of the total mass of the lubricating oil composition.

For example, a known pour point depressant such as a polymethacrylate polymer may be used as a pour point depressant other than the component (B) according to properties of the lubricant base oil to be used. When the lubricating oil composition comprises a pour point depressant, the content thereof is usually 0.05 to 1 mass % on the basis of the total mass of the lubricating oil composition.

A known corrosion inhibitor such as a benzotriazole, tolyltriazole, and imidazole compounds may be used as a corrosion inhibitor other than the component (H). When the lubricating oil composition comprises a corrosion inhibitor other than the component (H), the content thereof is usually 0.005 to 5 mass % on the basis of the total mass of the lubricating oil composition.

A known anti-rust agent such as petroleum sulfonate, alkylbenzenesulfonate, dinonylnaphthalenesulfonate, alkenylsuccinate esters, and polyol esters may be used as an anti-rust agent. When the lubricating oil composition comprises an anti-rust agent, the content thereof is usually 0.005 to 5 mass % on the basis of the total mass of the lubricating oil composition.

A known metal deactivator such as imidazoline, pyrimidine derivatives, mercaptobenzothiazole, benzotriazole and derivatives thereof, 2-(alkyldithio)benzimidazole, and β-(o-carboxybenzylthio)propionitrile may be used as a metal deactivator other than the component (H). When the lubricating oil composition comprises a metal deactivator other than the component (H), the content thereof is usually 0.005 to 5 mass % on the basis of the total mass of the lubricating oil composition.

A known anti-foaming agent such as silicones, fluorosilicones, and fluoroalkyl ethers may be used as an anti-foaming agent. When the lubricating oil composition comprises an anti-foaming agent, the content thereof is usually 0.0005 to 0.01 mass % on the basis of the total mass of the lubricating oil composition.

A known demulsifier such as polyalkylene glycol-based nonionic surfactants may be used as a demulsifier. When the lubricating oil composition comprises a demulsifier, the content thereof is usually 0.005 to 5 mass % on the basis of the total mass of the lubricating oil composition.

As a coloring agent, for example, a known coloring agent such as azo compounds may be used.

<Lubricating Oil Composition>

The kinematic viscosity of the lubricating oil composition at 40° C. is no more than 25 mm²/s; and in view of sufficient oil film formation at a lubricating point to improve anti-wear performance, preferably no less than 10 mm²/s, more preferably no less than 12 mm²/s, further preferably no less than 15 mm²/s, and particularly preferably no less than 20 mm²/s. The kinematic viscosity of the lubricating oil composition at 40° C. of no more than 25 mm²/s can improve fuel efficiency.

The kinematic viscosity of the lubricating oil composition at 100° C. is preferably no less than 5 mm²/s in view of sufficient oil film formation at a lubricating point to further improve anti-wear performance; and preferably no more than 8.0 mm²/s, more preferably no more than 7.0 mm²/s, and further preferably no more than 6.0 mm²/s, in view of further improvement in fuel efficiency.

The viscosity index of the lubricating oil composition is no less than 180. The upper limit of the viscosity index of the lubricating oil composition is usually, but not particularly limited to, no more than 300. The viscosity index of the lubricating oil composition of no less than 180 can reduce friction coefficients between metals under high sliding velocity conditions, to improve fuel efficiency.

The lubricating oil composition of the present invention meets the following formula (1):

0.5≤Mb/MCa≤1.5 (1)

wherein in the formula (1), Mb represents a boron content (unit: mass %) of the composition; and MCa represents a calcium content (unit: mass %) of the composition.

In the formula (1), the ratio Mb/MCa of no less than 0.5 can increase friction coefficients between metals under low sliding velocity conditions (friction coefficients between metals of a metal belt) and torque transmitting capacity of a wet clutch. The ratio Mb/MCa of no more than 1.5 can improve anti-seizure and anti-fatigue performance.

### EXAMPLES

Hereinafter the present invention will be more specifically described based on examples and comparative examples. The present invention is however not limited to these examples.

### Examples 1 to 19 and Comparative Examples 1 to 12

The lubricating oil compositions of the present invention (examples 1 to 19) and the lubricating oil compositions for comparison (comparative examples 1 to 12) were prepared as shown in Tables 1 to 6. In Tables, the content of each component is on the basis of the total mass (100 mass %) of the lubricating oil composition. Details on the components were as follows.

((A) Lubricant Base Oil)

A-1: wax-isomerized base oil (kinematic viscosity (40° C.): 9.072 mm²/s, kinematic viscosity (100° C.): 2.621 mm²/s, viscosity index: 127, sulfur content: less than 10 mass ppm, % C_{P}: 91.8, % C_{N}: 8.2, % C_{A}: 0)

A-2: wax-isomerized base oil (kinematic viscosity (40° C.): 15.65 mm²/s, kinematic viscosity (100° C.): 3.883 mm²/s, viscosity index: 142, sulfur content: less than 10 mass ppm, % C_{P}: 92.5, % C_{N}: 7.5, % C_{A}: 0)

A-3: hydrorefined mineral oil (kinematic viscosity (40° C.): 8.854 mm²/s, kinematic viscosity (100° C.): 2.464 mm²/s, viscosity index: 100, sulfur content: less than 10 mass ppm)

A-4: hydrorefined mineral oil (kinematic viscosity (40° C.): 12.43 mm²/s, kinematic viscosity (100° C.): 3.12 mm²/s, viscosity index: 112, sulfur content: less than 10 mass ppm)

((B) Poly(Meth)Acrylate)

B-1: non-dispersant poly(meth)acrylate, weight average molecular weight: 20,000

B-2: non-dispersant poly(meth)acrylate, weight average molecular weight: 50,000

B-3: non-dispersant poly(meth)acrylate, weight average molecular weight: 80,000

((C) Succinimide Compound)

C-1: boron-containing succinimide, B: 2.0 mass %, N: 2.3 mass %, weight average molecular weight: 4200

C-2: boron-containing succinimide, B: 0.49 mass %, N: 2.04 mass %, weight average molecular weight: 2400

C-3: non-boron-containing succinimide, N: 1.44 mass %, weight average molecular weight: 4500

((D) Borate Ester Compound)

D-1: boric acid mono(C₆₋₈ alkyl)ester, B: 2.83 mass %

((E) Calcium Detergent)

E-1: calcium sulfonate overbased with calcium carbonate, base number: 500 mgKOH/g, Ca: 18.4 mass %

E-2: calcium sulfonate overbased with calcium carbonate, base number: 300 mgKOH/g, Ca: 12.2 mass %

E-3: calcium salicylate overbased with calcium carbonate, base number: 280 mgKOH/g, Ca: 8.1 mass %

E-4: neutral calcium sulfonate, base number: 13 mgKOH/g, Ca: 2.51 mass %

((F) Phosphorus-Containing Anti-Wear Agent)

F-1: di(n-butyl) phosphite, P: 15.5 mass %

((G) Friction Modifier)

G-1: glycerol monooleate

G-2: condensation product of isostearic acid and tetraethylenepentamine

((H) Thiadiazole Compound)

H-1: thiadiazole compound having a hydrocarbyldithio group which is represented by any of the general formulae (6) to (8), S: 36 mass %

((I) Other Additives)

I-1: amine antioxidant

I-2: ethylene-α-olefin copolymer (weight average molecular weight: 8,600, kinematic viscosity (100° C.): 600 mm²/s)

I-3: dimethylsilicone anti-foaming agent, kinematic viscosity (25° C.): 60,000 mm²/s

TABLE 1

| Examples | | | | |
|---|---|---|---|---|
| 1 | 2 | 3 | 4 | 5 |

Base oil formulation (on the basis of the
total mass of the base oil)

| A-1 | mass % | 80.0 | 100.0 | 47.0 | 31.0 | 80.0 |
|---|---|---|---|---|---|---|
| A-2 | mass % | 20.0 | — | 53.0 | 69.0 | 20.0 |
| A-3 | mass % | — | — | — | — | — |
| A-4 | mass % | — | — | — | — | — |
| total | mass % | 100.0 | 100.0 | 100.0 | 100.0 | 100.0 |
| (A) Total base oil | | | | | | |
| content | mass % | 80.4 | 78.8 | 82.3 | 83.7 | 80.4 |
| kinematic viscosity (100° C.) | mm²/s | 2.8 | 2.6 | 3.2 | 3.4 | 2.8 |
| viscosity index | | 132 | 127 | 136 | 138 | 132 |
| (B) Poly(meth)acrylate | | | | | | |
| B-1 | mass % | 13.0 | 14.6 | 11.1 | 10.2 | 13.0 |
| B-2 | mass % | — | — | — | — | — |
| B-3 | mass % | — | — | — | — | — |
| (C) Succinimide | | | | | | |
| C-1 | mass % | 0.5 | 0.5 | 0.5 | 0.5 | 0.3 |
| C-2 | mass % | 2.0 | 2.0 | 2.0 | 2.0 | 1.3 |
| C-3 | mass % | 0.1 | 0.1 | 0.1 | 0.1 | 1.0 |
| content (in terms of boron) | mass % | 0.0198 | 0.0198 | 0.0198 | 0.0198 | 0.0124 |
| content (in terms of nitrogen) | mass % | 0.0537 | 0.0537 | 0.0537 | 0.0537 | 0.0478 |
| (D) Borate ester | | | | | | |
| D-1 | mass % | 0.30 | 0.30 | 0.30 | 0.30 | 0.30 |
| content (in terms of boron) | mass % | 0.0085 | 0.0085 | 0.0085 | 0.0085 | 0.0085 |
| Boron content in the composition (Mb) | mass % | 0.0283 | 0.0283 | 0.0283 | 0.0283 | 0.0209 |
| (E) Ca detergent | | | | | | |
| E-1 | mass % | — | — | — | — | — |
| E-2 | mass % | — | — | — | — | — |
| E-3 | mass % | 0.50 | 0.50 | 0.50 | 0.50 | 0.50 |
| E-4 | mass % | — | — | — | — | — |
| content (in terms of Ca) | mass % | 0.0405 | 0.0405 | 0.0405 | 0.0405 | 0.0405 |
| Formula (1): Mb/MCa | | 0.70 | 0.70 | 0.70 | 0.70 | 0.52 |
| (F) Phosphorus-containing anti-wear agent | | | | | | |
| F-1 | mass % | 0.45 | 0.45 | 0.45 | 0.45 | 0.45 |
| (G) Friction modifier | | | | | | |
| G-1 | mass % | 0.10 | 0.10 | 0.10 | 0.10 | 0.10 |
| G-2 | mass % | 0.50 | 0.50 | 0.50 | 0.50 | 0.50 |
| (H) Thiadiazole compound | | | | | | |
| H-1 | mass % | 0.15 | 0.15 | 0.15 | 0.15 | 0.15 |
| Other additives | | | | | | |
| I-1 | mass % | 0.5 | 0.5 | 0.5 | 0.5 | 0.5 |
| I-2 | mass % | 1.5 | 1.5 | 1.5 | 1.0 | 1.5 |
| I-3 | mass % | 0.003 | 0.003 | 0.003 | 0.003 | 0.003 |
| Total | mass % | 100.0 | 100.0 | 100.0 | 100.0 | 100.0 |
| Properties of the composition | | | | | | |
| kinematic viscosity (40° C.) | mm²/s | 21.0 | 21.5 | 21.4 | 22.3 | 21.1 |
| kinematic viscosity (100° C.) | mm²/s | 5.30 | 5.40 | 5.34 | 5.34 | 5.33 |
| viscosity index | | 204 | 205 | 201 | 188 | 205 |
| High-speed four-ball test (size of wear mark) | mm | 0.50 | 0.51 | 0.51 | 0.50 | 0.52 |
| FALEX seizure test | N | 4928 | 4492 | 4838 | 4480 | 4403 |
| Unisteel test (L50) | min | 1580 | 1601 | 1623 | 1530 | 1355 |

| | | | | | |
|---|---|---|---|---|---|
| SAE No. 2 test (μ_{d}) | 0.14 | 0.139 | 0.142 | 0.142 | 0.136 |
| LFW-1 test (friction coefficient between metals) | | | | | |
| slide speed 0.1 m/s | 0.105 | 0.105 | 0.103 | 0.106 | 0.105 |
| slide speed 1.0 m/s | 0.075 | 0.077 | 0.073 | 0.076 | 0.077 |
| MTM test (traction coefficient) | 0.022 | 0.022 | 0.022 | 0.022 | 0.023 |

TABLE 2

| Examples | | | | |
|---|---|---|---|---|
| 6 | 7 | 8 | 9 | 10 |

Base oil formulation (on the basis of the
total mass of the base oil)

| A-1 | mass % | 80.0 | 80.0 | 80.0 | 80.0 | 80.0 |
|---|---|---|---|---|---|---|
| A-2 | mass % | 20.0 | 20.0 | 20.0 | 20.0 | 20.0 |
| A-3 | mass % | — | — | — | — | — |
| A-4 | mass % | — | — | — | — | — |
| total | mass % | 100.0 | 100.0 | 100.0 | 100.0 | 100.0 |
| (A) Total base oil | | | | | | |
| content | mass % | 80.4 | 79.5 | 79.5 | 80.6 | 80.3 |
| kinematic viscosity (100° C.) | mm²/s | 2.8 | 2.8 | 2.8 | 2.8 | 2.8 |
| viscosity index | | 132 | 132 | 132 | 132 | 132 |
| (B) Poly(meth)acrylate | | | | | | |
| B-1 | mass % | 13.0 | 13.0 | 13.0 | 13.0 | 13.0 |
| B-2 | mass % | — | — | — | — | — |
| B-3 | mass % | — | — | — | — | — |
| (C) Succinimide | | | | | | |
| C-1 | mass % | 1.4 | 0.0 | 0.5 | 0.5 | 0.5 |
| C-2 | mass % | 0.3 | 3.0 | 3.0 | 2.0 | 2.0 |
| C-3 | mass % | 0.9 | 0.5 | 0.0 | 0.1 | 0.1 |
| content (in terms of boron) | mass % | 0.0295 | 0.0147 | 0.0247 | 0.0198 | 0.0198 |
| content (in terms of nitrogen) | mass % | 0.0513 | 0.0684 | 0.0727 | 0.0537 | 0.0537 |
| (D) Borate ester | | | | | | |
| D-1 | mass % | 0.30 | 0.30 | 0.30 | 0.07 | 0.35 |
| content (in terms of boron) | mass % | 0.0085 | 0.0085 | 0.0085 | 0.0020 | 0.0099 |
| Boron content in the composition (Mb) | mass % | 0.0380 | 0.0232 | 0.0332 | 0.0218 | 0.0297 |
| (E) Ca detergent | | | | | | |
| E-1 | mass % | — | — | — | — | — |
| E-2 | mass % | — | — | — | — | — |
| E-3 | mass % | 0.50 | 0.50 | 0.50 | 0.50 | 0.50 |
| E-4 | mass % | — | — | — | — | — |
| content (in terms of Ca) | mass % | 0.0405 | 0.0405 | 0.0405 | 0.0405 | 0.0405 |
| Formula (1): Mb/MCa | | 0.94 | 0.57 | 0.82 | 0.57 | 0.73 |
| (F) Phosphorus-containing anti-wear agent | | | | | | |
| F-1 | mass % | 0.45 | 0.45 | 0.45 | 0.45 | 0.45 |
| (G) Friction modifier | | | | | | |
| G-1 | mass % | 0.10 | 0.10 | 0.10 | 0.10 | 0.10 |
| G-2 | mass % | 0.50 | 0.50 | 0.50 | 0.50 | 0.50 |
| (H) Thiadiazole compound | | | | | | |
| H-1 | mass % | 0.15 | 0.15 | 0.15 | 0.15 | 0.15 |
| Other additives | | | | | | |
| I-1 | mass % | 0.5 | 0.5 | 0.5 | 0.5 | 0.5 |
| I-2 | mass % | 1.5 | 1.5 | 1.5 | 1.5 | 1.5 |
| I-3 | mass % | 0.003 | 0.003 | 0.003 | 0.003 | 0.003 |
| Total | mass % | 100.0 | 100.0 | 100.0 | 100.0 | 100.0 |
| Properties of the composition | | | | | | |
| kinematic viscosity (40° C.) | mm²/s | 21.2 | 20.9 | 21.0 | 21.2 | 21.3 |
| kinematic viscosity (100° C.) | mm²/s | 5.36 | 5.29 | 5.30 | 5.37 | 5.38 |
| viscosity index | | 206 | 205 | 205 | 206 | 206 |
| High-speed four-ball test (size of wear mark) | mm | 0.48 | 0.54 | 0.51 | 0.53 | 0.45 |
| FALEX seizure test | N | 5152 | 4226 | 4915 | 4301 | 4498 |
| Unisteel test (L50) | min | 1402 | 1395 | 1421 | 1428 | 1315 |

| | | | | | |
|---|---|---|---|---|---|
| SAE No. 2 test (μ_{d}) | 0.148 | 0.138 | 0.145 | 0.135 | 0.151 |
| LFW-1 test (friction coefficient between metals) | | | | | |
| slide speed 0.1 m/s | 0.118 | 0.105 | 0.112 | 0.104 | 0.119 |
| slide speed 1.0 m/s | 0.08 | 0.079 | 0.076 | 0.075 | 0.083 |
| MTM test (traction coefficient) | 0.023 | 0.023 | 0.022 | 0.022 | 0.022 |

TABLE 3

| Examples | | | | |
|---|---|---|---|---|
| 11 | 12 | 13 | 14 | 15 |

Base oil formulation (on the basis of the
total mass of the base oil)

| A-1 | mass % | 80.0 | 80.0 | 80.0 | 80.0 | 80.0 |
|---|---|---|---|---|---|---|
| A-2 | mass % | 20.0 | 20.0 | 20.0 | 20.0 | 20.0 |
| A-3 | mass % | — | — | — | — | — |
| A-4 | mass % | — | — | — | — | — |
| total | mass % | 100.0 | 100.0 | 100.0 | 100.0 | 100.0 |
| (A) Total base oil | | | | | | |
| content | mass % | 80.6 | 80.3 | 80.7 | 80.6 | 80.5 |
| kinematic viscosity (100° C.) | mm²/s | 2.8 | 2.8 | 2.8 | 2.8 | 2.8 |
| viscosity index | | 132 | 132 | 132 | 132 | 132 |
| (B) Poly(meth)acrylate | | | | | | |
| B-1 | mass % | 13.0 | 13.0 | 13.0 | 13.0 | 13.0 |
| B-2 | mass % | — | — | — | — | — |
| B-3 | mass % | — | — | — | — | — |
| (C) Succinimide | | | | | | |
| C-1 | mass % | 0.5 | 0.5 | 0.5 | 0.5 | 0.5 |
| C-2 | mass % | 2.0 | 2.0 | 2.0 | 2.0 | 2.0 |
| C-3 | mass % | 0.1 | 0.1 | 0.1 | 0.1 | 0.1 |
| content (in terms of boron) | mass % | 0.0198 | 0.0198 | 0.0198 | 0.0198 | 0.0198 |
| content (in terms of nitrogen) | mass % | 0.0537 | 0.0537 | 0.0537 | 0.0537 | 0.0537 |
| (D) Borate ester | | | | | | |
| D-1 | mass % | 0.30 | 0.30 | 0.30 | 0.30 | 0.30 |
| content (in terms of boron) | mass % | 0.0085 | 0.0085 | 0.0085 | 0.0085 | 0.0085 |
| Boron content in the composition (Mb) | mass % | 0.0283 | 0.0283 | 0.0283 | 0.0283 | 0.0283 |
| (E) Ca detergent | | | | | | |
| E-1 | mass % | — | — | 0.22 | — | 0.11 |
| E-2 | mass % | — | — | — | 0.33 | — |
| E-3 | mass % | 0.25 | 0.60 | — | — | 0.25 |
| E-4 | mass % | — | — | — | — | — |
| content (in terms of Ca) | mass % | 0.0203 | 0.0486 | 0.0405 | 0.0403 | 0.0405 |
| Formula (1): Mb/MCa | | 1.40 | 0.58 | 0.70 | 0.70 | 0.70 |
| (F) Phosphorus-containing anti-wear agent | | | | | | |
| F-1 | mass % | 0.45 | 0.45 | 0.45 | 0.45 | 0.45 |
| (G) Friction modifier | | | | | | |
| G-1 | mass % | 0.10 | 0.10 | 0.10 | 0.10 | 0.10 |
| G-2 | mass % | 0.50 | 0.50 | 0.50 | 0.50 | 0.50 |
| (H) Thiadiazole compound | | | | | | |
| H-1 | mass % | 0.15 | 0.15 | 0.15 | 0.15 | 0.15 |
| Other additives | | | | | | |
| I-1 | mass % | 0.5 | 0.5 | 0.5 | 0.5 | 0.5 |
| I-2 | mass % | 1.5 | 1.5 | 1.5 | 1.5 | 1.5 |
| I-3 | mass % | 0.003 | 0.003 | 0.003 | 0.003 | 0.003 |
| Total | mass % | 100.0 | 100.0 | 100.0 | 100.0 | 100.0 |
| Properties of the composition | | | | | | |
| kinematic viscosity (40° C.) | mm²/s | 20.9 | 21.0 | 21.2 | 21.2 | 21.1 |
| kinematic viscosity (100° C.) | mm²/s | 5.29 | 5.31 | 5.33 | 5.34 | 5.34 |
| viscosity index | | 205 | 205 | 204 | 205 | 206 |
| High-speed four-ball test (size of wear mark) | mm | 0.55 | 0.51 | 0.42 | 0.43 | 0.43 |
| FALEX seizure test | N | 4118 | 4448 | 5126 | 5152 | 5376 |
| Unisteel test (L50) | min | 1448 | 1325 | 1314 | 1632 | 1625 |

| | | | | | |
|---|---|---|---|---|---|
| SAE No. 2 test (μ_{d}) | 0.138 | 0.146 | 0.148 | 0.139 | 0.141 |
| LFW-1 test (friction coefficient between metals) | | | | | |
| slide speed 0.1 m/s | 0.106 | 0.118 | 0.111 | 0.109 | 0.113 |
| slide speed 1.0 m/s | 0.071 | 0.083 | 0.084 | 0.081 | 0.074 |
| MTM test (traction coefficient) | 0.022 | 0.022 | 0.023 | 0.022 | 0.021 |

TABLE 4

| Examples | | | |
|---|---|---|---|
| 16 | 17 | 18 | 19 |

Base oil formulation (on the basis of the
total mass of the base oil)

| A-1 | mass % | 80.0 | 80.0 | — | 30.0 |
|---|---|---|---|---|---|
| A-2 | mass % | 20.0 | 20.0 | 50.0 | 40.0 |
| A-3 | mass % | — | — | 25.0 | 30.0 |
| A-4 | mass % | — | — | 25.0 | — |
| total | mass % | 100.0 | 100.0 | 100.0 | 100.0 |
| (A) Total base oil | | | | | |
| content | mass % | 80.3 | 79.3 | 80.9 | 81.5 |
| kinematic viscosity (100° C.) | mm²/s | 2.8 | 2.8 | 3.2 | 3.0 |
| viscosity index | | 132 | 132 | 123 | 126 |
| (B) Poly(meth)acrylate | | | | | |
| B-1 | mass % | 13.0 | 13.0 | 14.6 | 14.0 |
| B-2 | mass % | — | — | — | — |
| B-3 | mass % | — | — | — | — |
| (C) Succinimide | | | | | |
| C-1 | mass % | 0.3 | 0.5 | 0.5 | 0.5 |
| C-2 | mass % | 1.0 | 3.0 | 2.0 | 2.0 |
| C-3 | mass % | 1.3 | 0.5 | 0.1 | 0.1 |
| content (in terms of boron) | mass % | 0.0109 | 0.0247 | 0.0198 | 0.0198 |
| content (in terms of nitrogen) | mass % | 0.0460 | 0.0799 | 0.0537 | 0.0537 |
| (D) Borate ester | | | | | |
| D-1 | mass % | 0.35 | 0.20 | 0.20 | 0.20 |
| content (in terms of boron) | mass % | 0.0099 | 0.0057 | 0.0057 | 0.0057 |
| Boron content in the composition (Mb) | mass % | 0.0208 | 0.0304 | 0.0255 | 0.0255 |
| (E) Ca detergent | | | | | |
| E-1 | mass % | — | — | — | — |
| E-2 | mass % | — | — | — | — |
| E-3 | mass % | 0.50 | 0.25 | 0.50 | 0.50 |
| E-4 | mass % | — | — | — | — |
| content (in terms of Ca) | mass % | 0.0405 | 0.0203 | 0.0405 | 0.0405 |
| Formula (1): Mb/MCa | | 0.51 | 1.50 | 0.63 | 0.63 |
| (F) Phosphorus-containing anti-wear agent | | | | | |
| F-1 | mass % | 0.45 | 0.45 | 0.45 | 0.45 |
| (G) Friction modifier | | | | | |
| G-1 | mass % | 0.10 | 0.10 | 0.10 | 0.10 |
| G-2 | mass % | 0.50 | 0.50 | 0.50 | 0.50 |
| (H) Thiadiazole compound | | | | | |
| H-1 | mass % | 0.15 | 0.15 | 0.15 | 0.15 |
| Other additives | | | | | |
| I-1 | mass % | 0.5 | 0.5 | — | — |
| I-2 | mass % | 1.5 | 1.5 | — | — |
| I-3 | mass % | 0.003 | 0.003 | — | — |
| Total | mass % | 100.0 | 100.0 | 100.0 | 100.0 |
| Properties of the composition | | | | | |
| kinematic viscosity (40° C.) | mm²/s | 21.2 | 21.0 | 22.4 | 21.8 |
| kinematic viscosity (100° C.) | mm²/s | 5.35 | 5.32 | 5.43 | 5.40 |
| viscosity index | | 205 | 206 | 193 | 200 |
| High-speed four-ball test (size of wear mark) | mm | 0.58 | 0.44 | 0.50 | 0.48 |
| FALEX seizure test | N | 4403 | 5560 | 4583 | 4699 |
| Unisteel test (L50) | min | 1325 | 1385 | 1612 | 1608 |

| | | | | |
|---|---|---|---|---|
| SAE No. 2 test (μ_{d}) | 0.137 | 0.152 | 0.142 | 0.142 |
| LFW-1 test (friction coefficient between metals) | | | | |
| slide speed 0.1 m/s | 0.104 | 0.121 | 0.105 | 0.108 |
| slide speed 1.0 m/s | 0.07 | 0.088 | 0.074 | 0.073 |
| MTM test (traction coefficient) | 0.022 | 0.022 | 0.030 | 0.025 |

TABLE 5

| | | Comparative examples | | | | | |
|---|---|---|---|---|---|---|---|
| | | 1 | 2 | 3 | 4 | 5 | 6 |
| Base oil formulation (on | | | | | | | |
| the basis of the total | | | | | | | |
| mass of the base oil) | | | | | | | |
| A-1 | mass % | — | 80.0 | 80.0 | 80.0 | 80.0 | 80.0 |
| A-2 | mass % | — | 20.0 | 20.0 | 20.0 | 20.0 | 20.0 |
| A-3 | mass % | 42.0 | — | — | — | — | — |
| A-4 | mass % | 58.0 | — | — | — | — | — |
| total | mass % | 100.0 | 100.0 | 100.0 | 100.0 | 100.0 | 100.0 |
| (A) Total base oil | | | | | | | |
| content | mass % | 80.1 | 88.4 | 90.1 | 80.4 | 80.4 | 80.7 |
| kinematic viscosity (100° C.) | mm²/s | 2.8 | 2.8 | 2.8 | 2.8 | 2.8 | 2.8 |
| viscosity index | | 108 | 132 | 132 | 132 | 132 | 132 |
| (B) Poly(meth)acrylate | | | | | | | |
| B-1 | mass % | 12.0 | — | — | 13.0 | 13.0 | 13.0 |
| B-2 | mass % | — | 5.0 | — | — | — | — |
| B-3 | mass % | — | — | 3.3 | — | — | — |
| (C) Succinimide | | | | | | | |
| C-1 | mass % | 0.5 | 0.5 | 0.5 | 0.3 | 2.0 | 0.5 |
| C-2 | mass % | 3.0 | 2.0 | 2.0 | 0.3 | 0.3 | 2.0 |
| C-3 | mass % | 0.5 | 0.1 | 0.1 | 2.0 | 0.3 | 0.1 |
| content (in terms of boron) | mass % | 0.0247 | 0.0198 | 0.0198 | 0.0075 | 0.0415 | 0.0198 |
| content (in terms of nitrogen) | mass % | 0.0799 | 0.0537 | 0.0537 | 0.0418 | 0.0564 | 0.0537 |
| (D) Borate ester | | | | | | | |
| D-1 | mass % | 0.20 | 0.30 | 0.30 | 0.30 | 0.30 | 0.03 |
| content (in terms of boron) | mass % | 0.0057 | 0.0085 | 0.0085 | 0.0085 | 0.0085 | 0.0008 |
| Boron content in the | mass % | 0.0304 | 0.0283 | 0.0283 | 0.0160 | 0.0500 | 0.0206 |
| composition (Mb) | | | | | | | |
| (E) Ca detergent | | | | | | | |
| E-1 | mass % | — | — | — | — | — | — |
| E-2 | mass % | — | — | — | — | — | — |
| E-3 | mass % | 0.50 | 0.50 | 0.50 | 0.50 | 0.50 | 0.50 |
| E-4 | mass % | — | — | — | — | — | — |
| content (in terms of Ca) | mass % | 0.0405 | 0.0405 | 0.0405 | 0.0405 | 0.0405 | 0.0405 |
| Formula (1): Mb/MCa | | 0.75 | 0.70 | 0.70 | 0.39 | 1.23 | 0.52 |
| (F) Phosphorus-containing | | | | | | | |
| anti-wear agent | | | | | | | |
| F-1 | mass % | 0.45 | 0.45 | 0.45 | 0.45 | 0.45 | 0.45 |
| (G) Friction modifier | | | | | | | |
| G-1 | mass % | 0.10 | 0.10 | 0.10 | 0.10 | 0.10 | 0.10 |
| G-2 | mass % | 0.50 | 0.50 | 0.50 | 0.50 | 0.50 | 0.50 |
| (H) Thiadiazole compound | | | | | | | |
| H-1 | mass % | 0.15 | 0.15 | 0.15 | 0.15 | 0.15 | 0.15 |
| Other additives | | | | | | | |
| I-1 | mass % | 0.5 | 0.5 | 0.5 | 0.5 | 0.5 | 0.5 |
| I-2 | mass % | 1.5 | 1.5 | 1.5 | 1.5 | 1.5 | 1.5 |
| I-3 | mass % | 0.003 | 0.003 | 0.003 | 0.003 | 0.003 | 0.003 |
| Total | mass % | 100.0 | 100.0 | 100.0 | 100.0 | 100.0 | 100.0 |
| Properties of the composition | mm²/s | 22.6 | 22.8 | 24.9 | 21.1 | 21.5 | 21.4 |
| kinematic viscosity (40° C.) | | | | | | | |
| kinematic viscosity (100° C.) | mm²/s | 5.34 | 5.31 | 5.34 | 5.34 | 5.41 | 5.40 |
| viscosity index | | 184 | 179 | 156 | 206 | 205 | 206 |
| High-speed four-ball test | mm | 0.55 | 0.52 | 0.55 | 0.65 | 0.41 | 0.61 |
| (size of wear mark) | | | | | | | |
| FALEX seizure test | N | 4048 | 4404 | 4323 | 4315 | 3470 | 4003 |
| Unisteel test (L50) | min | 1389 | 1411 | 1358 | 1398 | 1115 | 1369 |
| SAE No. 2 test (μ_{d}) | | 0.141 | 0.142 | 0.141 | 0.133 | 0.146 | 0.129 |
| LFW-1 test (friction | | 0.111 | 0.11 | 0.111 | 0.099 | 0.115 | 0.089 |
| coefficient between metals) | | | | | | | |
| slide speed 0.1 m/s | | | | | | | |
| slide speed 1.0 m/s | | 0.081 | 0.098 | 0.095 | 0.061 | 0.094 | 0.081 |
| MTM test (traction coefficient) | | 0.043 | 0.024 | 0.025 | 0.022 | 0.022 | 0.023 |

TABLE 6

| | | Comparative examples | | | | | |
|---|---|---|---|---|---|---|---|
| | | 7 | 8 | 9 | 10 | 11 | 12 |
| Base oil formulation (on | | | | | | | |
| the basis of the total | | | | | | | |
| mass of the base oil) | | | | | | | |
| A-1 | mass % | 80.0 | 80.0 | 80.0 | 80.0 | 80.0 | 80.0 |
| A-2 | mass % | 20.0 | 20.0 | 20.0 | 20.0 | 20.0 | 20.0 |
| A-3 | mass % | — | — | — | — | — | — |
| A-4 | mass % | — | — | — | — | — | — |
| total | mass % | 100.0 | 100.0 | 100.0 | 100.0 | 100.0 | 100.0 |
| (A) Total base oil | | | | | | | |
| content | mass % | 80.2 | 80.8 | 79.9 | 80.5 | 80.6 | 79.3 |
| kinematic viscosity (100° C.) | mm²/s | 2.8 | 2.8 | 2.8 | 2.8 | 2.8 | 2.8 |
| viscosity index | | 132 | 132 | 132 | 132 | 132 | 132 |
| (B) Poly(meth)acrylate | | | | | | | |
| B-1 | mass % | 13.0 | 13.0 | 13.0 | 13.0 | 13.0 | 13.0 |
| B-2 | mass % | — | — | — | — | — | — |
| B-3 | mass % | — | — | — | — | — | — |
| (C) Succinimide | | | | | | | |
| C-1 | mass % | 0.5 | 0.5 | 0.5 | 0.3 | 1.4 | 0.5 |
| C-2 | mass % | 2.0 | 2.0 | 2.0 | 1.0 | 0.3 | 2.0 |
| C-3 | mass % | 0.1 | 0.1 | 0.1 | 1.3 | 0.9 | 0.1 |
| content (in terms of boron) | mass % | 0.0198 | 0.0198 | 0.0198 | 0.0109 | 0.0295 | 0.0198 |
| content (in terms of nitroqen) | mass % | 0.0537 | 0.0537 | 0.0537 | 0.0460 | 0.0513 | 0.0537 |
| (D) Borate ester | | | | | | | |
| D-1 | mass % | 0.50 | 0.30 | 0.30 | 0.11 | 0.35 | 0.30 |
| content (in terms of boron) | mass % | 0.0142 | 0.0085 | 0.0085 | 0.0031 | 0.0099 | 0.0085 |
| Boron content in the | mass % | 0.0340 | 0.0283 | 0.0283 | 0.0140 | 0.0394 | 0.0283 |
| composition (Mb) | | | | | | | |
| (E) Ca detergent | | | | | | | |
| E-1 | mass % | — | — | — | — | — | — |
| E-2 | mass % | — | — | — | — | — | — |
| E-3 | mass % | 0.50 | 0.10 | 1.00 | 0.60 | 0.25 | — |
| E-4 | mass % | — | — | — | — | — | 1.60 |
| content (in terms of Ca) | mass % | 0.0405 | 0.0081 | 0.0810 | 0.0486 | 0.0203 | 0.0402 |
| Formula (1): Mb/MCa | | 0.84 | 3.49 | 0.35 | 0.29 | 1.94 | 0.70 |
| (F) Phosphorus-containing | | | | | | | |
| anti-wear agent | | | | | | | |
| F-1 | mass % | 0.45 | 0.45 | 0.45 | 0.45 | 0.45 | 0.45 |
| (G) Friction modifier | | | | | | | |
| G-1 | mass % | 0.10 | 0.10 | 0.10 | 0.10 | 0.10 | 0.10 |
| G-2 | mass % | 0.50 | 0.50 | 0.50 | 0.50 | 0.50 | 0.50 |
| (H) Thiadiazole compound | | | | | | | |
| H-1 | mass % | 0.15 | 0.15 | 0.15 | 0.15 | 0.15 | 0.15 |
| Other additives | | | | | | | |
| I-1 | mass % | 0.5 | 0.5 | 0.5 | 0.5 | 0.5 | 0.5 |
| I-2 | mass % | 1.5 | 1.5 | 1.5 | 1.5 | 1.5 | 1.5 |
| I-3 | mass % | 0.003 | 0.003 | 0.003 | 0.003 | 0.003 | 0.003 |
| Total | mass % | 100.0 | 100.0 | 100.0 | 100.0 | 100.0 | 100.0 |
| Properties of the composition | mm²/s | 21.4 | 21.5 | 21.1 | 21.5 | 21.4 | 21.4 |
| kinematic viscosity (40° C.) | | | | | | | |
| kinematic viscosity (100° C.) | mm²/s | 5.38 | 5.39 | 5.34 | 5.40 | 5.41 | 5.38 |
| viscosity index | | 205 | 204 | 206 | 205 | 206 | 204 |
| High-speed four-ball test | mm | 0.64 | 0.61 | 0.66 | 0.52 | 0.41 | 0.68 |
| (size of wear mark) | | | | | | | |
| FALEX seizure test | N | 3425 | 3357 | 3470 | 4403 | 3381 | 3425 |
| Unisteel test (L50) | min | 1111 | 1121 | 1085 | 1368 | 1036 | 1316 |
| SAE No. 2 test (μ_{d}) | | 0.132 | 0.31 | 0.134 | 0.134 | 0.143 | 0.132 |
| LFW-1 test (friction | | 0.087 | 0.077 | 0.099 | 0.098 | 0.108 | 0.95 |
| coefficient between metals) | | | | | | | |
| slide speed 0.1 m/s | | | | | | | |
| slide speed 1.0 m/s | | 0.078 | 0.068 | 0.092 | 0.059 | 0.071 | 0.085 |
| MTM test (traction coefficient) | | 0.024 | 0.024 | 0.022 | 0.023 | 0.022 | 0.022 |

(High-Speed Four-Ball Test)

Anti-wear performance of each of the lubricating oil compositions was evaluated by a high-speed four-ball test conforming to JPI-5S-40-93. The size of a wear mark after driving at 1200 rpm in rotation speed at 392 N in load and 80° C. in oil temperature for 30 minutes was measured. The results are shown in Tables 1 to 6. In this test, a smaller size of a wear mark means better anti-wear performance. The size of a wear mark in this test is preferably no more than 0.60 mm.

(FALEX Seizure Test)

Load capacity of each of the lubricating oil compositions was evaluated by a FALEX seizure test conforming to ASTM D3233. Under the condition of oil temperature at 110° C., a steel pin that was sandwiched by two stationary steel V-shaped blocks was rotated at 290 rpm, and the load at which seizure occurred was measured. The results are shown in Tables 1 to 6. In this test, it can be determined that the heavier load at which seizure occurs, the better anti-seizure performance (load capacity) is. In this test, the load at which seizure occurs is preferably no less than 3900 N.

(Unisteel Test)

For each lubricating oil composition, a rolling fatigue life of a thrust bearing was measured by a Unisteel test (IP305/79, The Institute of Petroleum) using a Unisteel rolling fatigue testing machine (triple-type high-temperature rolling fatigue testing machine (TRF-1000/3-01H) manufactured by Tokyo Koki Testing Machine Co. Ltd.). Time until either a roller or a test piece suffered fatigue damage was measured for a test bearing made by replacement of a bearing ring in one side of a thrust needle bearing (FNTA-2542C manufactured by NSK Ltd.) with a flat test piece (material: SUJ2), under the conditions of: 7000 N in load; 2 GPa in surface pressure; 1450 rpm in rotation speed; and 120° C. in oil temperature. It was determined that fatigue damage occurred when the vibration acceleration of a testing portion measured by a vibration accelerometer installed in the Unisteel rolling fatigue testing machine reached 1.5 m/s². The test was repeated ten times, and then a fatigue life was calculated as the 50% life (L50: time for the cumulative probability to be 50%) by a Weibull plot based on the time it had taken for fatigue damage to occur in the tests. The results are shown in Tables 1 to 6. A longer 50% life measured in this test means better anti-fatigue performance. In this test, measured 50% life is preferably no less than 1200 minutes.

(SAE No. 2 Friction Test)

A dynamic friction test was carried out on each of the lubricating oil compositions using SAE No. 2 Tester (manufactured by Shinko Engineering Co., Ltd.) conforming to JASO M348: 2002, to measure coefficients of dynamic friction μ_{d} between a friction plate and a steel plate. The results are shown in Tables 1 to 6. A higher coefficient of dynamic friction μ_{d} measured in this test means better engaging performance of a wet clutch, that is, a larger torque transmitting capacity of a wet clutch. The coefficient of dynamic friction μ_{d} measured in this test is preferably no less than 0.135.

(LFW-1 Test)

Friction coefficients between metals (coefficient of dynamic friction) of each of the lubricating oil compositions was measured conforming to JASO M358-2005 (Standard Test Method for Metal on Metal Friction Characteristics of Belt CVT Fluids) with a block-on-ring friction and wear testing machine (LFW-1), except that the load was changed to 222 N. The test conditions were: block H60, ring S10, load 222 N, oil temperature 80° C.,

(1) slide speed 0.1 m/s, and
(2) slide speed 1.0 m/s
to measure friction coefficients between metals. The results are shown in Tables 1 to 6. A higher friction coefficient between metals measured in this test at (1) slide speed: 0.1 m/s means a higher friction coefficient between metals under low sliding velocity conditions (torque transmitting capacity of a metal belt). In this test, the friction coefficient between metals measured at (1) slide speed: 0.1 m/s is preferably no less than 0.100. A lower friction coefficient between metals measured in this test at (2) slide speed: 1.0 m/s means a lower friction coefficient between metals under high sliding velocity conditions (friction coefficient in sliding between gears, bearings, etc.), and a higher degree of fuel efficiency. In this test, the friction coefficient between metals measured at (2) slide speed: 1.0 m/s is preferably no less than 0.090.

(MTM Test)

A ball-on-disk friction test was carried out on each of the lubricating oil compositions using a MTM traction machine (manufactured by PCS Instruments), to measure traction coefficients. The measurement conditions were as follows:

ball and disk: standard test pieces (AISI 52100 standard)

oil temperature: 80° C.

load: 50 N

speed: 1 m/s

slip rate: 50%

The results are shown in Tables 1 to 6. A lower traction coefficient measured in this test means a less friction under elastohydrodynamic lubrication conditions, and higher fuel efficiency. The traction coefficient measured in this test is preferably no more than 0.03.

(Evaluation Results)

The lubricating oil compositions of examples 1 to 19 showed good results in friction coefficients between metals under low sliding velocity conditions and high sliding velocity conditions, anti-seizure performance, anti-wear performance, anti-fatigue performance, torque transmitting capacity of a wet clutch, and traction coefficients.

The lubricating oil composition of comparative example 1, where the (A) lubricant base oil did not comprise a wax-isomerized base oil but consisted of hydrorefined mineral oils, was inferior in traction coefficients.

The lubricating oil compositions of comparative examples 2 and 3, where the component (B) had a too large weight average molecular weight respectively, were inferior in friction coefficients between metals under high sliding velocity conditions.

The lubricating oil composition of comparative example 4, where the content of the component (C) in terms of boron was too low, was inferior in friction coefficients between metals under low sliding velocity conditions, anti-wear performance, and torque transmitting capacity of a wet clutch.

The lubricating oil composition of comparative example 5, where the content of the component (C) in terms of boron was too high, was inferior in friction coefficients between metals under high sliding velocity conditions, anti-seizure performance, and anti-fatigue performance.

The lubricating oil composition of comparative example 6, where the content of the component (D) was too low, was inferior in friction coefficients between metals under low sliding velocity conditions, anti-wear performance, and torque transmitting capacity of a wet clutch.

The lubricating oil composition of comparative example 7, where the content of the component (D) was too high, was inferior in friction coefficients between metals under low sliding velocity conditions, anti-wear performance, anti-seizure performance, anti-fatigue performance, and torque transmitting capacity of a wet clutch.

The lubricating oil composition of comparative example 8, where the content of the component (E) was too low, and the ratio Mb/MCa was too high in the formula (1), was inferior in friction coefficients between metals under low sliding velocity conditions, anti-seizure performance, anti-wear performance, anti-fatigue performance, and torque transmitting capacity of a wet clutch.

The lubricating oil composition of comparative example 9, where the content of the component (E) was too high, and the ratio Mb/MCa was too low in the formula (1), was inferior in friction coefficients between metals under low sliding velocity conditions, friction coefficients between metals under high sliding velocity conditions, anti-wear performance, anti-seizure performance, anti-fatigue performance, and torque transmitting capacity of a wet clutch. The lubricating oil composition of comparative example 10, where the ratio Mb/MCa was too low in the formula (1), was inferior in friction coefficients between metals under low sliding velocity conditions, and torque transmitting capacity of a wet clutch.

The lubricating oil composition of comparative example 11, where the ratio Mb/MCa was too high in the formula (1), was inferior in anti-seizure performance, and anti-fatigue performance.

The lubricating oil composition of comparative example 12, where a neutral calcium detergent was used instead of the component (E), was inferior in friction coefficients between metals under low sliding velocity conditions, anti-wear performance, anti-seizure performance, anti-fatigue performance, and torque transmitting capacity of a wet clutch.

I/We claim:

1. A lubricating oil composition for a push-belt continuously variable transmission, the composition comprising:
(A) a lubricant base oil having a kinematic viscosity at 100° C. of 2.5 to 3.5 mm²/s and a viscosity index of no less than 120, the (A) lubricant base oil comprising (A1) at least one wax-isomerized base oil in an amount of no less than 50 mass % on the basis of the total mass of the lubricant base oil;
(B) at least one poly(meth)acrylate having a weight average molecular weight of 15,000 to 40,000, in an amount of 10 to 20 mass % on the basis of the total mass of the composition;
(C) at least one boron-containing succinimide compound, in an amount of 0.01 to 0.03 mass % in terms of boron on the basis of the total mass of the composition;
(D) at least one borate ester compound, in an amount of 0.002 to 0.010 mass % in terms of boron on the basis of the total mass of the composition; and
(E) at least one calcium salicylate detergent overbased with calcium carbonate and having a base number of 200 to 600 mgKOH/g, or at least one calcium sulfonate detergent overbased with calcium carbonate and having a base number of 200 to 600 mgKOH/g, or any combination thereof, in an amount of 0.01 to 0.05 mass % in terms of calcium on the basis of the total mass of the composition,
wherein the composition has a kinematic viscosity at 40° C. of no more than 25 mm²/s;
the composition has a viscosity index of no less than 180; and
the composition meets the following formula (1):
0.5≤Mb/MCa≤1.5 (1)
wherein in the formula (1), Mb represents a boron content (unit: mass %) of the composition; and MCa represents a calcium content (unit: mass %) of the composition.

2. The lubricating oil composition according to claim 1,
wherein the component (D) is at least one borate ester compound represented by the following general formula (2): 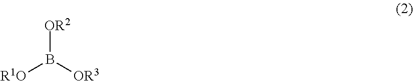
wherein in the general formula (2), R¹ is a hydrocarbyl group having 1 to 30 carbons; and R² and R³ are each independently a hydrogen atom or a hydrocarbyl group having 1 to 30 carbons.

3. The lubricating oil composition according to claim 1, further comprising:
(F) at least one phosphorus-containing anti-wear agent, in an amount of 0.01 to 0.2 mass % in terms of phosphorus on the basis of the total mass of the composition.

4. The lubricating oil composition according to claim 1, further comprising:
(G) at least one ashless friction modifier, in an amount of 0.01 to 5.0 mass % on the basis of the total mass of the composition.
